(19) United States
(12) Patent Application Publication
(10) Pub. No.: US 2008/0018847 A1
(43) Pub. Date: Jan. 24, 2008

(54) Light source device

(75) Inventor: Wan-Chun Chen, Jhubei City (TW)

Correspondence Address: LIU & LIU, 444 S. FLOWER STREET, SUITE 1750, LOS ANGELES, CA, 90071, US

(73) Assignee: TPO Displays Corp.

(21) Appl. No.: 11/490,547

(22) Filed: Jul. 21, 2006

(51) Int. Cl. G02F 1/1345

(52) U.S. Cl. 349/149

(57) ABSTRACT

A system for displaying image comprising an OLED panel. The OLED panel comprises a display area, a power line and a cathode line. The U-shaped power line is located on the first side, the second side and the third side of the OLED panel. The cathode line is located on the fourth side of the OLED panel.

### BACKGROUND OF THE INVENTION

1. Field of the Invention

The invention relates to an organic light emitting diode device. In particular, the invention relates to an active matrix organic light emitting diode.

2. Description of the Related Art

FIG. 1 shows a conventional AMOLED (Active Matrix Organic Light Emitting Diode) device 1. AMOLED device 1 comprises panel 10 and Flexible printed circuit (FPC) 12. Panel 10 comprises power line 14 and cathode line 15. Power line 14 comprises four sections 14a, 14b, 14c and 14d. FPC (flexible printed circuit) 12 has FPC power lines 13-1, 13-2, 13-3 and 13-4 and a FPC cathode line 19. FPC power lines 13-1 and 13-2 are coupled to the power line 14a, FPC power lines 13-3 and 13-4 are coupled to power lines 14b and 14d respectively and FPC cathode line 19 is coupled to cathode line 15. Cathode line 15 is located on one side of the panel. Power line 14 surrounds panel 10 and supplies stable power.

However, while power lines 14d and 14a, cathode line 15 and FPC 12 are located at the top right corner of the panel 10 and only power lines 14b and 14C are located at the bottom left corner of the panel 10, the temperature at the top right corner of panel 10 is higher than that at the bottom left corner of panel 10 because there are more circuits at the top right corner of panel 10 than the bottom left corner of panel 10. Thus, the panel can't emit light uniformly. In addition, because power lines 14a, 14b, 14c and 14d and cathode line 15 occupy a lot of panel area, the available emitting light area becomes less.

### BRIEF SUMMARY OF THE INVENTION

To solve the above-mentioned problem, the invention provides a system for displaying image, comprising an OLED panel. The OLED panel comprises a display area, four sides around the display area, a power line located on at least one side and a cathode line located on another side, wherein the power line and the cathode line located on different side. The power line can be U-shape, L-shape and strip shape.

### BRIEF DESCRIPTION OF THE DRAWINGS

The invention can be more fully understood by reading the subsequent detailed description and examples with references made to the accompanying drawings, wherein:

FIG. 1 shows a conventional AMOLED device.

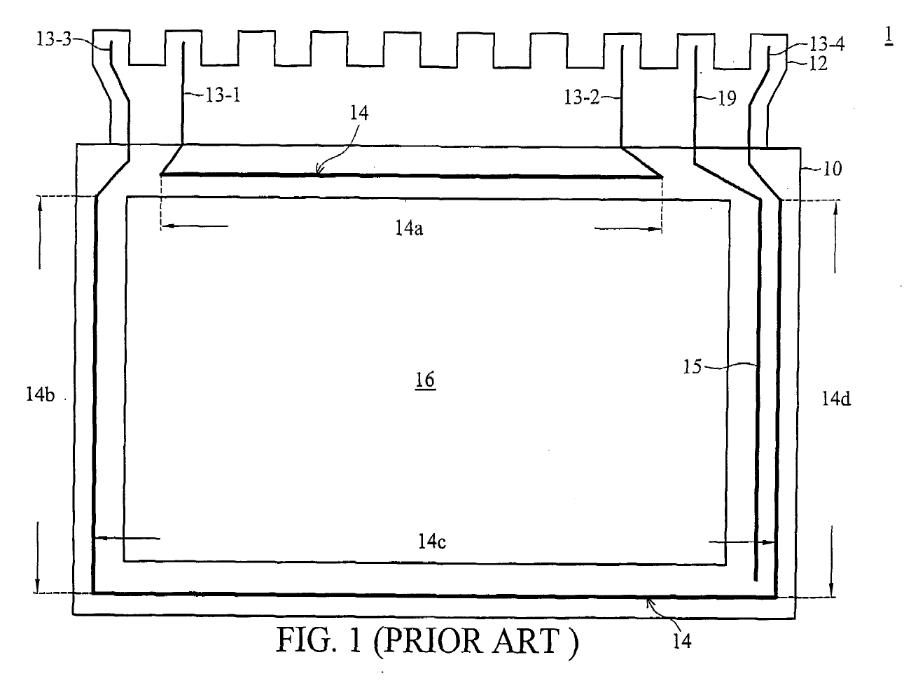

FIG. 2 shows an AMOLED device according to an embodiment of the invention.

FIG. 3 shows an AMOLED device according to another embodiment of the invention.

FIG. 4 shows an AMOLED device according to another embodiment of the invention.

FIG. 5 shows an AMOLED device according to another embodiment of the invention.

FIG. 6 schematically shows another embodiment of a system for displaying images.

### DETAILED DESCRIPTION OF THE INVENTION

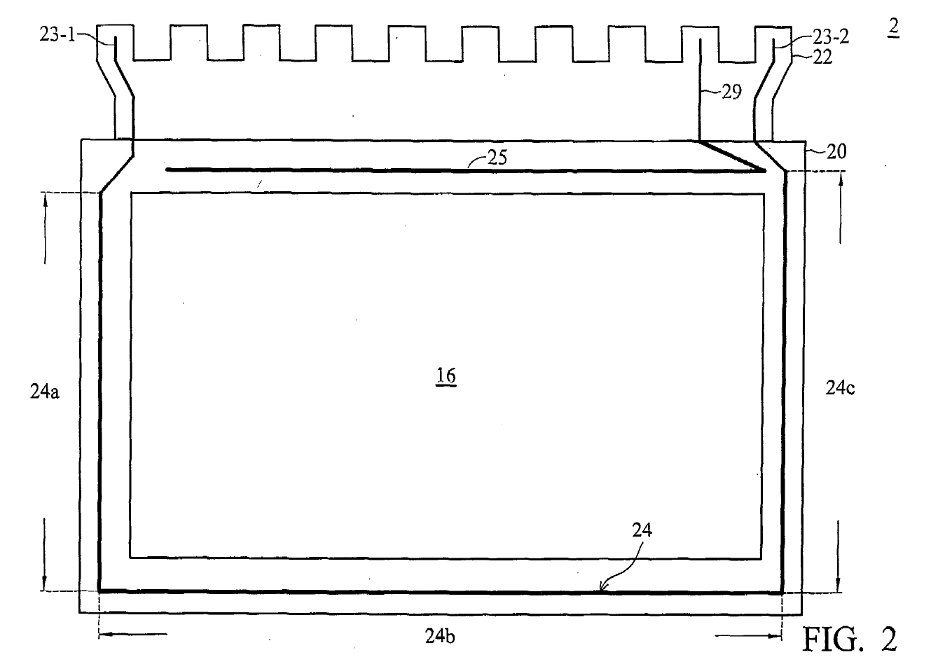

FIG. 2 shows an AMOLED device 2 according to an embodiment of the invention. AMOLED device 2 comprises panel 20 and Flexible printed circuit 22. Panel 20 comprises display area 16, power line 24 and cathode line 25. Power line 24 comprises three sections 24a, 24b and 24c to form a U-shape power line. Cathode line 25 is located on one side of panel 20. U-shape power line 24 is located on the other three sides of panel 20. Flexible printed circuit 22 has FPC power lines 23-1 and 23-2 and FPC cathode line 29. FPC power line 23-1 is coupled to power line 24a. FPC power line 23-2 is coupled to power line 24c. FPC cathode line 29 is coupled to cathode line 25. Current flows from FPC power lines 23-1 and 23-2 through power lines 24a, 24c and 24b to display area 16 and then from display area 16 through cathode line 25 to FPC cathode line 29. Unlike the conventional panel 10, panel 20 of the embodiment uses one less side of power line. Thus, panel 20 has a larger light emitting area. It also reduces circuits at the top right corner of the panel to lower temperature at the top right corner of the panel. The temperature at panel 20 is more uniform, so panel 20 emits light more uniformly.

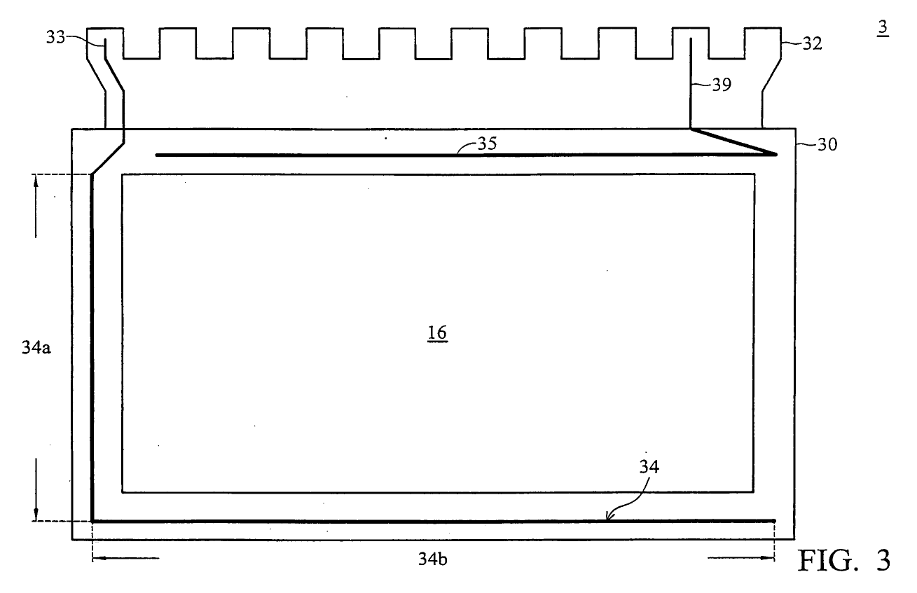

FIG. 3 shows an AMOLED device 3 according to another embodiment of the invention. AMOLED device 3 comprises panel 30 and Flexible printed circuit 32. Panel 30 comprises display area 16, power line 34 and cathode line 35. Power line 34 comprises two sections 34a and 34b to form a L-shape power line. Cathode line 35 is located on one side of panel 30. L-shape power line 34 is located on two adjacent sides of the panel. Flexible printed circuit 32 has FPC power line 33 and FPC cathode line 39. FPC power line 33 is coupled to power line 34a. FPC cathode line 39 is coupled to cathode line 35. Current flows from FPC power line 33 serially through power line 34a and power line 34b to display area 16 and then from display area 16 serially through cathode line 35 to FPC cathode line 39. Unlike panel 20 with three sides of power line, panel 30 uses one less side of power line, so panel 30 has a larger light emitting area. The number of circuits is also reduced at the top left corner of the panel to lower temperature at the top left corner of the panel. The temperature at panel 30 is more uniform, so panel 30 emits light more uniformly.

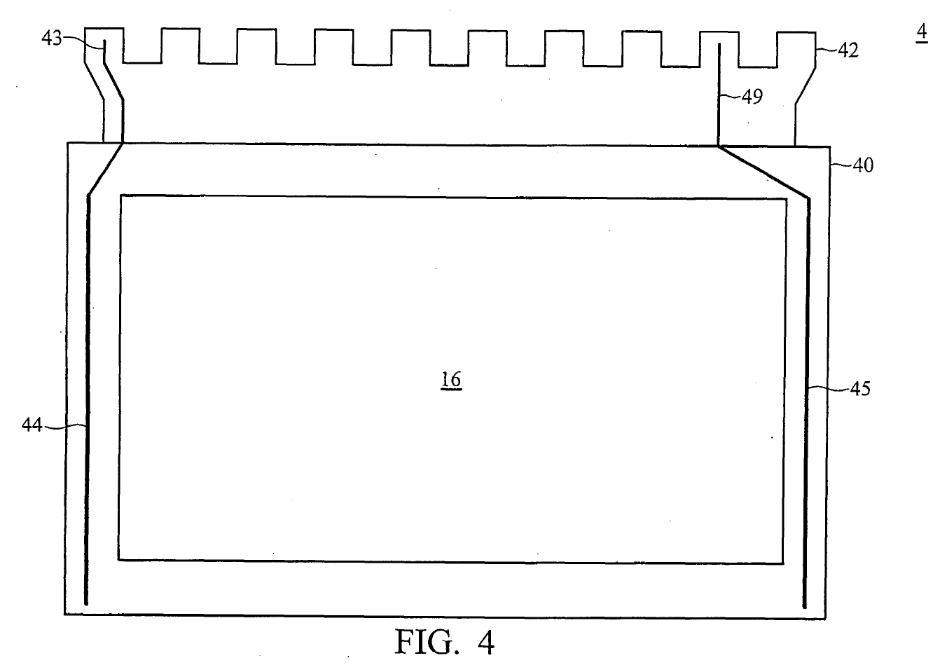

FIG. 4 shows an AMOLED device 4 according to another embodiment of the invention. AMOLED device 4 comprises panel 40 and Flexible printed circuit 42. Panel 40 comprises display area 16, power line 44, and cathode line 45. Power line 44 is located on the opposite side of cathode line 45 of panel 40. Power line 44 and cathode line 45 are symmetrically disposed on the panel 40. Flexible printed circuit 42 has FPC power line 43 and FPC cathode line 49. FPC power line 43 is coupled to power line 44. FPC cathode line 49 is coupled to cathode line 45. Current flows from FPC power line 43 serially through power line 44 to display area 16 and then from display area 16 serially through cathode line 45 to FPC cathode line 49.

Unlike panel 30 with two sides of power line, panel 40 uses one less side of power line. Thus, panel 40 has a larger light emitting area. It also reduces the number of circuits at the top left corner of the panel to lower temperature at the top left corner of the panel.

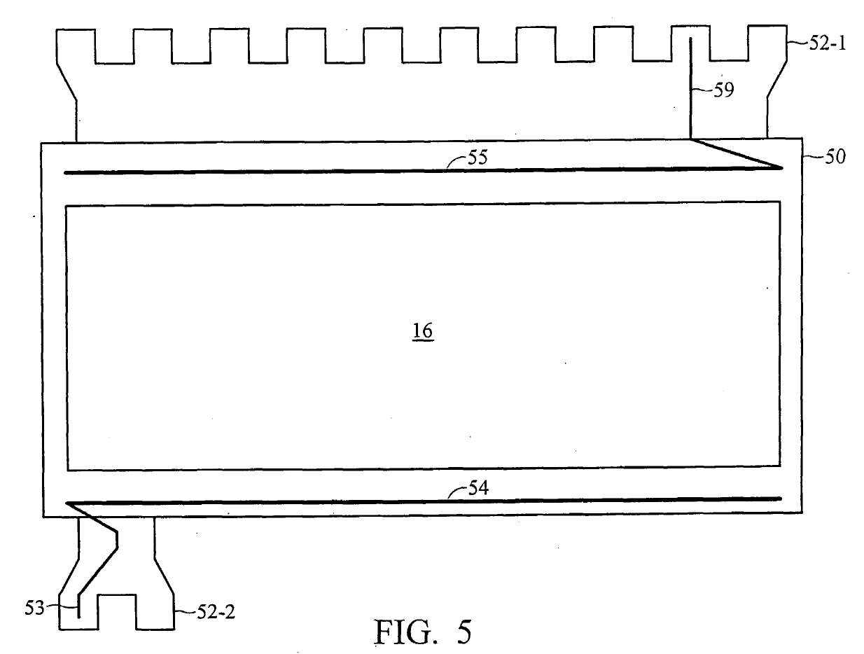

FIG. 5 shows an AMOLED device 5 according to another embodiment of the invention. AMOLED device 5 comprises panel 50 and flexible printed circuits 52-1 and 52-2. Panel 50 comprises display area 16, power line 54, and cathode line 55. Cathode line 55 is located on one long side of panel 50. Power line 54 is located on the opposite side of cathode line 55 of panel 50. Power line 54 and cathode line 55 are symmetrically disposed on the panel 50. Flexible printed circuit 52-1 has FPC cathode line 59. Flexible printed circuit 52-2 has FPC power line 53. FPC power line 53 is coupled to power line 54. FPC cathode line 59 is coupled to cathode line 55. Current flows from FPC power line 53 serially through power line 54 to display area 16 and then from display area 16 serially through cathode line 55 to FPC cathode line 59. Unlike panel 30 with two sides of power line, panel 50 only has one power line, so panel 50 has a larger light emitting area.

According to the embodiments of the invention of FIG. 4 and FIG. 5, the power line and cathode line are symmetrically disposed on the panel. It avoids the conventional panel problem that relative circuits are too concentrated at the top right corner of the panel and the temperature at the top left corner of the panel is higher than the other place of the panel. Since the voltage and temperature of the panel are more uniform, the panel of the embodiments emits light more uniformly. The lifetime of the panel also increases. In addition, the power line and the cathode line are disposed on opposite side of the panel that simplifies circuit design.

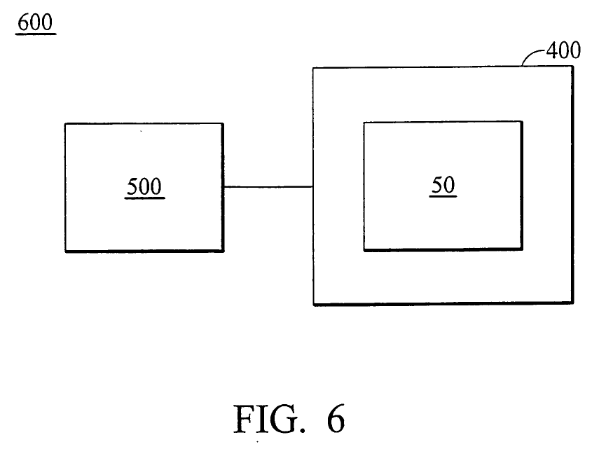

FIG. 6 schematically shows another embodiment of a system for displaying images, which, in this case, is implemented as display device 400 or electronic device 600. The described active matrix organic electroluminescent device can be incorporated into a display device that can be an OLED device. As shown in FIG. 6, display device 400 comprises an active matrix organic electroluminescent device, such as the active matrix organic electroluminescent panel 20, 30, 40 and 50 shown in FIG. 2, FIG. 3, FIG. 4 and FIG. 5. Display device 400 can form a portion of a variety of electronic devices (in this case, electronic device 600). Generally, electronic device 600 can comprise display device 400 and input unit 500. Further, input unit 500 is operatively coupled to display device 400 and provides input signals (e.g., an image signal) to display device 400 to generate images. Electronic device 600 can be a mobile phone, digital camera, PDA (personal data assistant), notebook computer, desktop computer, television, car display, or portable DVD player, for example.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for displaying image, comprising:
an OLED panel, comprising:
a display area and four sides around the display area;
a power line located on at least one side; and
a cathode line located on another side;
wherein the power line and the cathode line located on different side.

2. The system device as claimed in claim 1, wherein the OLED panel is an active matrix organic light emitting diode panel.

3. The system as claimed in claim 1, wherein the OLED panel is quadrilateral.

4. The system as claimed in claim 1, further comprising:
a flexible printed circuit (FPC), comprising:
two FPC power lines supplying power and coupled to the power line; and
a FPC cathode line coupled to the cathode line.

5. The system device as claimed in claim 1, wherein the power line located on a first side, a second side and a third side to form a U-shape.

6. The system device as claimed in claim 1, wherein the power line located on a first side and a second side to form an L-shape.

7. The system device as claimed in claim 1, wherein the power line located on a first side and the cathode line located on an opposite side.

8. The system as claimed in claim 1, further comprising a display device, wherein the OLED panel forms a portion of the display device.

9. The system as claimed in claim 1, further comprising an electronic device, wherein the electronic device comprises:
the display device; and
an input unit coupled to the display device and operative to provide input to the display device such that the display device displays image.
